(19) United States
(12) Patent Application Publication
(10) Pub. No.: US 2025/0356553 A1
(43) Pub. Date: Nov. 20, 2025

(54) CUSTOMIZING DIGITAL COMPONENTS USING ARTIFICIAL INTELLIGENCE

(71) Applicant: Google LLC, Mountain View, CA (US)

(72) Inventors: Haifeng Gong, Fremont, CA (US); Jiachen Wang, San Jose, CA (US); Xiaohang Li, Cupertino, CA (US)

(21) Appl. No.: 18/894,882

(22) Filed: Sep. 24, 2024

Related U.S. Application Data
(60) Provisional application No. 63/649,540, filed on May 20, 2024.

(51) Int. Cl. G06T 11/60; G06F 40/279; G06T 7/11

(52) U.S. Cl. CPC G06T 11/60; G06F 40/279; G06T 7/11; G06T 2207/20132

(57) ABSTRACT

Methods, systems, and apparatus, including computer programs encoded on a computer storage medium, for automated digital component generation. In some aspects, a method includes obtaining digital content data for the digital component. The digital content data includes at least a base image of a subject of the digital component. A prompt that includes a description of the subject is obtained. The prompt is processed using a language model to generate one or more keywords related to the subject. A determination is made, based on the one or more keywords, one or more style features for the digital component. The digital component is generated by processing the digital content data based at least on the one or more determined style features. The generated digital component is distributed to one or more client devices.

### CROSS-REFERENCE TO RELATED APPLICATION

This application claims priority to U.S. Provisional Patent Application No. 63/649,540, filed on May 20, 2024, the disclosure of which is hereby incorporated by reference in its entirety and for all purposes.

### BACKGROUND

This specification relates to data processing, artificial intelligence, and generating and customizing digital components using artificial intelligence.

In a computer networked environment such as the Internet, third-party content providers provide third-party content items for display on end-user computing devices. These third-party content items, for example, digital images and video, can be displayed on client devices in the environment. Digital images and video can be used, for example, on the Internet, for remote meetings via video conferencing, high-definition video entertainment, and/or sharing of user-generated content.

Recent developments in artificial intelligence and, in particular, generative artificial intelligence have caused user-produced visual content such as digital images to become ubiquitous. For example, various types of images can be generated by using a text-to-image models based on text prompts. However, current generative artificial intelligence models often produce inaccurate and/or low quality images.

### SUMMARY

This specification describes methods, computer systems, and apparatus, including computer programs encoded on computer storage media, for generating and customizing digital components based on a collection of information and/or other content related to subjects of the digital components.

In general, one innovative aspect of the subject matter described in this specification can be embodied in methods that include the actions of obtaining digital content data for the digital component, the digital content data comprising at least a base image of a subject of the digital component; obtaining a prompt comprising a description of the subject; processing the prompt using a language model to generate one or more keywords related to the subject; determining, based on the one or more keywords, one or more style features for the digital component; generating the digital component by processing the digital content data based at least on the one or more determined style features; and distributing the generated digital component to one or more client devices. Other implementations of this aspect include corresponding apparatus, systems, and computer programs, configured to perform the aspects of the methods, encoded on computer storage devices.

These and other embodiments can each optionally include one or more of the following features. Some aspects include storing a set of structured data items with each respective structured data item linking a respective set of one or more keywords with a respective set of one or more style features. Determining, based on the one or more keywords, the one or more style features of the digital component can include identifying, in the set of structured data items, the one or more style features as a respective set of style features that are linked to the one or more keywords.

Some aspects include determining salient features of the base image and cropping the base image based on the determined salient features such that the cropped base image includes the determined salient features and an additional are for adding text to the image. Determining the salient features of the base image can include processing the base image using a feature detection machine learning model to generate an output identifying the salient features of the base image.

In some aspects, the one or more style features include one or more image effect. Generating the digital component can include applying the one or more image effects to the base image. The one or more image effects can include a brightness adjustment effect, a contrast adjustment effect, a sharpen or blur effect, a color adjustment effect, a distortion effect, a 3D image effect, or a torn edge effect.

In some aspects, the digital content data includes a text item, and generating the digital component comprises overlaying the text item on the base image. Overlaying the text item on the base image can include determining a display position of the text item relative to the base image in the digital component. Determining the display position of the text item relative to the base image can include determining a set of one or more areas in the base image that are outside of salient features of the base image and selecting the display position in a first area in the set of one or more areas.

In some aspects, the one or more style features include one or more text style features for the text item, and generating the digital component comprises applying the one or more text style features to the text item in the generated digital component. The one or more text style features can include one or more of: a font typeface, a font color, a font weight, a font style, a text alignment, a text spacing, or one or more text display effects.

In some aspects, the digital content data includes an interactive element. Generating the digital component can include combining the interactive element with the base image. Combining the interactive element with the base image can include determining a display position of the interactive element relative to the base image in the digital component. The one or more style features can include one or more element style features for the interactive element. Generating the digital component can include applying the one or more element style features to the interactive element in the generated digital component. In some aspects, the one or more element style features can include one or more of: a button shape, a button color, or a button pattern.

Some aspects include performing contextual learning of the language model using a set of examples, each example comprising a respective input description and a respective output set of keywords.

Particular embodiments of the subject matter described in this specification can be implemented so as to realize one or more of the following advantages. This specification describes techniques for enabling artificial intelligence (AI) to generate and customize digital components by combining an image with other content (e.g., text and/or interactive elements such as buttons). The AI system customizes each generated digital component with one or more style features tailored to the digital component's subject matter, enhancing its ability to effectively deliver information and capture audience attention and/or engagement.

There are a number of technical challenges faced when trying to automate the generation and customization of digital components. The system needs to accurately understand the context of the subject to effectively determine the appropriate style choices. In an illustrative example, the subject of the digital component includes a digital poster for a children's party. In this case, the style features should convey an atmosphere of fun and excitement, and can include features such as bright colors, a cartoonish font like Comic Sans, and image effects such as enhanced color saturation. In another illustrative example, the subject of the digital component includes a digital poster for a sports car. In this case, the style features should convey an atmosphere of luxury, modernity, and excitement, and can include features such as sleek metallic colors, bold geometric fonts, and image effects such as motion blur to suggest speed or a stylized spotlight effect on the car.

Furthermore, the system needs to select styles that not only fit the subject but also create a visually cohesive and pleasing overall design. Failure to choose suitable or optimized styles may lead to low-quality and underperforming candidate digital components, resulting in wasteful consumption of computational resources through testing numerous inadequate options. For example, the testing for each candidate digital component can include generating the digital component, transmitting the candidate digital component to many users, collecting data related to user interactions with the candidate digital components, and generating and analyzing performance metrics based on the collected data. The generation and testing of many digital components result in substantial amounts of wasted computing resources in generating the candidate digital components and collecting the data, and wasted network bandwidth in transmitting the candidate digital components to the users and collecting the data.

Another technical challenge faced when trying to automate the generation of digital components that combine images with other contents is related to the occlusion of objects and/or the ability to perceive the information being conveyed. For example, when the text and/or other content is overlaid on the image, a portion (or all) of a salient feature of the image (e.g., a human face or an important component depicting the subject) may be occluded, such that the viewer is unable to visually perceive the salient feature. In another example, portions of the image may be cluttered or have a color palette that does not have a sufficient level of contrast relative to the other content (e.g., the text or the interactive element), such that the other content may not be readily discernible from the background image. In these situations, the creation of the new digital component results in wasted computing resources and time because those resources and time have been utilized to generate imperceivable content, such that the system has failed to create the intended output, in addition to the wasted resources in transmitting and evaluating the performance of the digital components as described above.

The processes discussed herein include operations that configure the AI system to overcome the above technical challenges, for example, by selecting styles for a digital component that fit the subject and provide a cohesive and pleasing overall design, and by ensuring objects depicted in the images are un-occluded by the overlayed elements. The disclosed techniques result in improved quality of automatically generated digital components and saving of computing resources that would have been wasted for generating and evaluating sub-optimal digital components. In particular, the pipeline for customizing digital components described herein includes stages that employ machine learning models to detect the salient region of an image, select text and/or interactive elements to include in the image, crop the image such that the salient region is prominent in the resulting digital component, select a location in the image for the text based on the location of the salient region, and format the text and/or interactive element based on the content of the image in the selected location to ensure that the text is readable and visibly appealing to users that view the digital component, thereby resulting in a higher quality image than those resulting from image customization processed that do not include such stages.

Furthermore, the techniques described herein provide particular uses of AI to solve problems associated with generating and customizing digital components that effectively deliver information and capture audience attention, by employing language models to analyze the subject matter and select appropriate style features. In the context of automating the generation of digital components, it is important to accurately understand the context of the subject to make suitable style choices, and ensure that the selected styles create a visually cohesive design. The described techniques leverage AI technology, specifically, in some implementations, large language models, to process prompts describing the subject matter and to generate keywords that guide the selection of style features. By automating the style selection process based on contextual understanding, rather than relying on manual or rule-based approaches, the described techniques represent an advancement in addressing the technical challenge of creating high-quality, engaging digital components that resonate with their intended audience.

Additionally, by using an AI model, e.g., a language model, to generate keywords related to the subject of a digital component and then using those keywords to generate style features solves problems arising in generative AI by dividing the digital component design into discrete tasks that generative AI models are capable of performing accurately. For example, providing a large amount of data and requesting generative AI models to output multiple types of data often results in hallucinations and other errors in the model outputs. Identifying the keywords and using those keywords to generate style features results in higher quality and more relevant designs than submitting images and prompts to an AI model requesting the same output. Thus, the sequence of operations is a specific use of AI to generate higher quality digital components. Additionally, the use of discrete tasks enables the use of smaller, less complex AI models that are trained on specific tasks, which results in higher quality digital components that can be produced faster and using fewer computing resources as compared to using a single general purpose language model for all tasks based on a single prompt.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example environment in which generative artificial intelligence can be implemented.

FIG. 2 illustrates interactions between an AI system, a language model, a client device, and a memory structure.

FIG. 3 is a flow chart of an example process of generating a digital component.

FIG. 4 is a block diagram of an example computer.

Like reference numbers and designations in the various drawings indicate like elements.

### DETAILED DESCRIPTION

This specification describes techniques for enabling artificial intelligence (AI) to generate and customize digital components by combining an image with other content (e.g., text and interactive elements such as buttons). The AI system customizes each generated digital component with one or more style features tailored to the digital component's subject matter, enhancing its ability to effectively deliver information and capture audience attention and/or engagement.

AI is a segment of computer science that focuses on the creation of models that can perform tasks act autonomously, e.g., with little to no human intervention. AI systems can utilize, for example, one or more of machine learning, natural language processing, or computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

The techniques described throughout this specification enable the automated creation of new digital components, for example, by combining an image with other content and customizing the digital components with one or more style features tailored to the digital component's subject matter.

To facilitate the generation of a digital component that effectively delivers information relevant to the subject and captures audience attention and/or engagement, while also overcoming the technical challenges described above, the present techniques/system submits a prompt including a description of the subject of the digital component to a language model to cause the language model to output keywords that can be used to select the style features. In this way, the AI system can generate the digital components in ways that will reduce/eliminate the generation of digital components that have low quality and performance.

As used throughout this document, the phrase “digital component” refers to a discrete unit of digital content or digital information (e.g., a video clip, audio clip, multimedia clip, gaming content, image, text, combination of image and text, bullet point, artificial intelligence output, language model output, or another unit of content or unit of combined content). A digital component can electronically be stored in a physical memory device as a single file or in a collection of files, and digital components can take the form of video files, audio files, multimedia files, image files, or text files and include advertising information, such that an advertisement is a type of digital component.

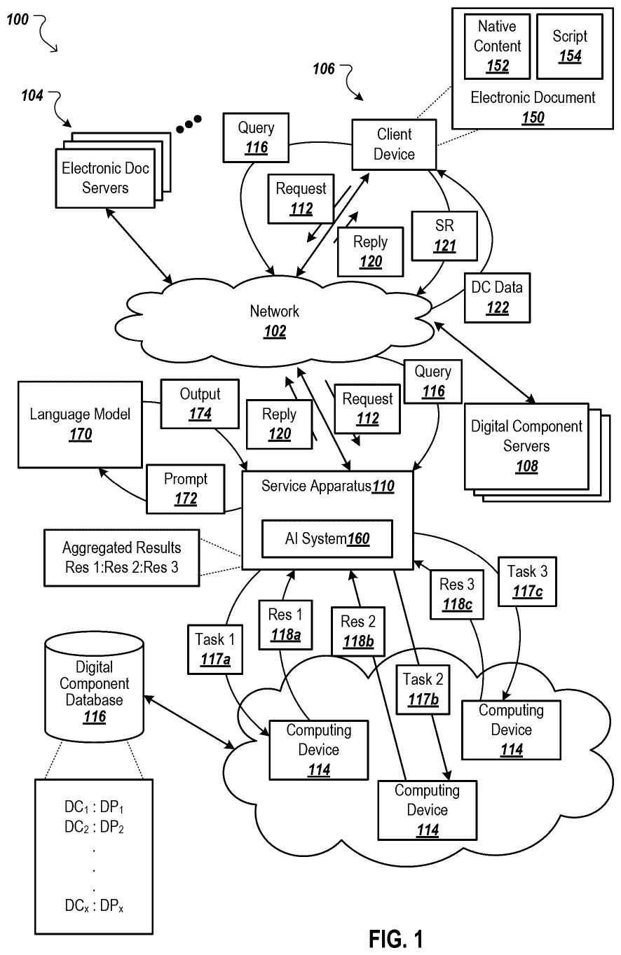

FIG. 1 illustrates an example environment 100 in which generative artificial intelligence can be implemented. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, client devices 106, and digital component servers 108.

A client device 106 is an electronic device capable of requesting and receiving online resources over the network 102. Example client devices 106 include personal computers, gaming devices, mobile communication devices, tablet devices, digital assistant devices, augmented reality devices, virtual reality devices, wearable devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords/topics/categories that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an AI system 160 configured to autonomously generate digital components, either prior to a request 112 (e.g., offline) and/or in response to a request 112 (e.g., online or real-time). The AI system 160 can collect online content about a specific entity (e.g., digital component provider or another entity) and summarize the collected online content using one or more language models 170, which can include large language models. Note that the language model 170 is depicted as being separate from the service apparatus 110 and the AI system 160, but the language model 170 can be integrated into the service apparatus 110 and/or the AI system 160.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution (e.g., a probability distribution) that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

The service apparatus 110 and/or AI system 160 is configured to combine an image with other content, e.g., text, other images, graphics, emojis, interactive elements, etc., to create a new digital component. For example, assume that the text “The Big Game is Live Friday at the Coliseum” is available to be combined with a selected image that was obtained for the category “sports.” In this example, the service apparatus 110 and/or AI system 160 can overlay the text over the image to create the new digital component. In turn, the new digital component can be made available for distribution to client devices 106, e.g., in response to a request for content in the category “sports”.

For example, the new digital component can be stored in the digital component database 116 with a reference to distribution parameters and/or other information about the digital component. The distribution parameters for the new digital component can include the category of the new digital component (e.g., sports in this example). When the service apparatus 110 receives a request 112 for content specifying the category, the digital component database 116 can be searched to identify the match between the category in the request and the category to which the new digital component is indexed. Based on the match, the service apparatus 110 can select the new digital component for distribution, and transmit the new digital component to a client device in response to the request 112.

The description above refers to the new digital component being created prior to receipt of the request 112. However, in some implementations, the new digital component can be created after the service apparatus 110 receives the request for content in the category. For example, the service apparatus 110 can store digital content data for a digital component campaign for which newly generated digital components are distributed to client devices 106. The digital content data can include one or more images of a subject of the digital component campaign (e.g., images of a truck that is the subject of the campaign) and text related to the subject (e.g., a title, description, headline for digital components, and/or text from other digital components for the subject). In this example, when a request 112 is received, the service apparatus 110 can select an image and text for the digital component and generate the digital component using the selected image and text.

The set of images can be related to a given category. Similarly, text available for distribution in response to content requests specifying the given category can be stored in a database with data specifying the given category. In this example, when the service apparatus 110 receives the content request specifying the given category, the service apparatus 110 can use the given category to search databases for images and text that are each stored with data specifying the given category. When an image and text are identified using the given query, the image and text can be combined to create the new digital component, which is then transmitted to the client device in response to the content request. In this way, the creation of the new digital component can be dynamic in nature, and can therefore, leverage other information in the request that may not be known prior to receipt of the request (e.g., a time of day of the request). This dynamic creation of the new digital components can also reduce the storage requirements of pre-generating the new digital components because only one instance of each image and one instance of each set of text needs to be stored, while still being able to create all combinations of text and images as new digital components.

In some implementations, the AI system 160 can generate a prompt 172 that is submitted to the language model 170, and causes the language model 170 to generate the output sequences 174, also referred to as “output”. In some cases, the AI system 160 can generate the prompt in a manner (e.g., having a structure) that identifies a list of online sources of information, such as a list of websites or data repositories, and specifying a set of constraints the language model 160 must use to generate a summary of information found at the online sources specified in the prompt 172. To initiate creation of the output sequences 174, the AI system 160 submits the prompt 172 to the language model 170, which uses the prompt 172 to evaluate the information found at the online sources specified in the prompt 172, and generate the output 174 that summarizes the information according to the constraints specified in the prompt 172.

In some implementations, the collected information can be used to classify entities into a hierarchical semantic structure. For example, based on the information collected for one entity, or a subset of available resources, the output 174 can be a categorization/sub-categorization of the information collected. In a specific example, assume that a set of resources (e.g., online web pages or files) is related to a bakery specializing in birthday cakes. In this example, the information collected can be used to assign the set of resources (e.g., for a particular entity) to the category of “bakery” and sub-category “birthday cakes” that is a sub-category of “bakery.” In this way, the category to which a given set of resources is semantically related can be determined, assigned to the set of resources and/or entity, and used as, at least part of, a summary of the set of resources and/or the entity. Note that the phrase category, as used herein, can be used to refer to both categories and sub-categories, and the term sub-category is used to differentiate a subordinate from a more general category to which the sub-category belongs.

In some cases, the AI system 160 can obtain a description prompt describing a subject of the new digital component, e.g., an entity associated with the new digital component. In one example, the AI system 160 can insert the generated summary into an additional prompt that is submitted to the language model 170 (or another language model) as a constraint for generating the description prompt. The description prompt can be used as an input to the language model 170 (or another language model) to condition the language model to output a set of keywords characterizing the subject. As will be described below, the AI system 160 can use the keywords to select one or more style features for the digital component.

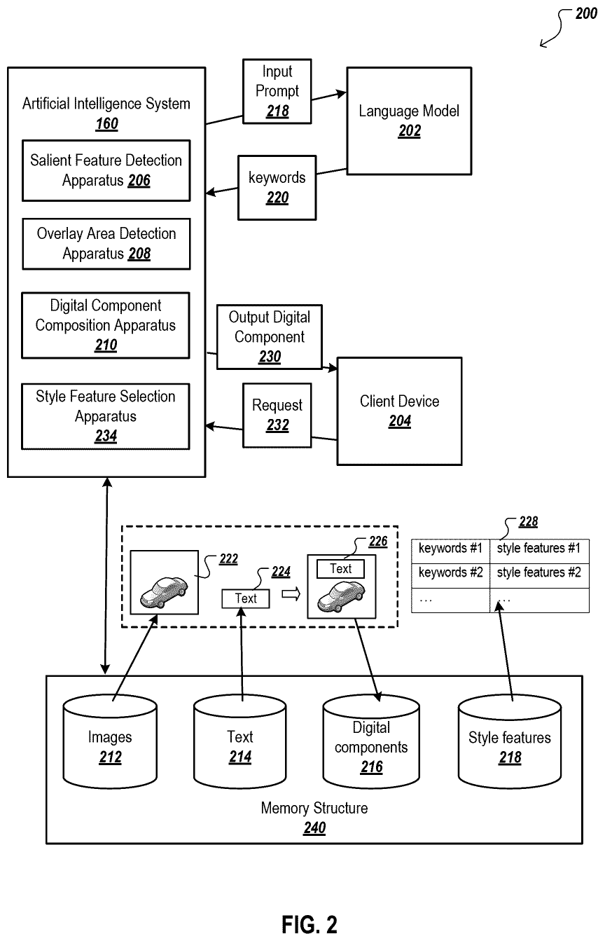

FIG. 2 is a block diagram 200 illustrating interactions between the AI system 160, the language model 202, a client device 204, and a memory structure 240. In some situations, the language model 202 and client device 204 can, respectively, be the same or similar to the language model 170 and client device 106 of FIG. 1.

The AI system 160 includes a salient feature detection apparatus 206, an overlay area detection apparatus 208, a digital component composition apparatus 210, and a style feature selection apparatus 234. The following description refers to these different apparatuses as being implemented independently and each configured to perform a set of operations, but any of these apparatuses could be combined to perform the operations discussed below. Furthermore, the transmissions of data between various components can occur over any communications bus or network.

The AI system 160 is in communication with a memory structure 214. The memory structure 240, can include one or more databases or other appropriate structures/software for storing data. As shown, the memory structure 214 includes an image database 212 storing images, a text database 214 storing text items, a digital components database 216 storing digital components, and a style feature database 218 storing selections of style features. Each of these databases can be implemented in a same hardware memory device, separate hardware memory devices, and/or implemented in a distributed cloud computing environment. In some cases, the memory structure 214 can store interactive elements and/or data for creating the interactive elements. The interactive elements can include, for example, buttons, checkboxes, and interactive icons or animations that can be included in digital components.

The digital component composition apparatus 210 is implemented using at least one computing device (e.g., one or more processors), and can include one or more machine learning models. In some cases, the digital component composition apparatus 210 is configured to combine an image 222 from the image database 212 with other content to create a new digital component 226. The other content can include text, such as a headline (e.g., up to 30 or another appropriate number of characters) that highlights the message being conveyed by the digital component 226 and a description (e.g., up to 90 or another appropriate number of characters) that provides context about the subject of the digital component 226. The other content can also include interactive elements, e.g., buttons, icons, or clickable links. The other content can also include a logo highlighting an entity associated with the subject of the digital component 226 or the subject itself.

In one example, the digital component composition apparatus 210 can overlay the text 224 selected from text database 214 over the image 222 selected from the image database 212 to create the new digital component 226 that includes both the image 222 and the text 224.

In another example, the digital component composition apparatus 210 can overlay other types of content, such as interactive elements (e.g., buttons or clickable links) over the image 222. The image 222 is selected to illustrate the subject (such as an object, a theme, an entity, an event, or a message) of the digital component. In some cases, the image 222 has been generated using a generative model, e.g., the language model 202. In some other cases, the image 222 has been generated through photography or artwork.

Before combining the image 222 with the other contents, the AI system 160 can determine the overlay location of the text 224 or the interactive element. In some cases, the AI system 160 also crops the base image 222, e.g., to a specific aspect ratio, so the generated digital component 226 can fit into a space assigned to the digital component for presentation.

The salient feature detection apparatus 206 is implemented using at least one computing device (e.g., one or more processors), and can include one or more machine learning models. The salient feature detection apparatus 206 is configured to detect salient features in the image 222. In this specification, salient features in an image can refer to areas of the image that include features related to the subject of the image, e.g., a truck of the truck is the subject of the image. The salient features can also include elements that stand out, draw a viewer's attention, and are considered the most important or defining parts of the image. Salient features can be areas of high contrast in color, brightness, or texture, elements that stand out due to their uniqueness, or recognizable objects that hold meaning to the viewer (like human faces or familiar items).

In some implementations, the salient feature detection apparatus 206 processes the base image using a feature detection machine learning model to generate an output map identifying areas corresponding to the salient features of the base image. For example, the output map can specify the x and y coordinates of the salient features ion the image. The feature detection machine learning model can be implemented with any suitable model architectures and machine learning techniques.

After the salient features of the image 222 have been determined, the AI system 160 can crop the image 222 such that the cropped image includes the salient features. The AI system 160 can be configured to crop the image 222 such that the image includes the salient features and additional area for adding additional content. In some implementations, the AI system 160 determines how to crop the image based on the image itself and the additional content that will be added to the image. For example, the AI system 160 can determine how to crop the image based on the amount of text and/or the size of the interactive item that will be added to the image. In some cases, the AI system 160 can use an image cropping machine learning model to process an input specifying the uncropped image, the detected salient features, and optionally data characterizing the additional content to generate an output that specify the cropped image. For example, the output of the image cropping machine learning model can include the coordinates specifying a rectangle area of the cropped image.

The overlay area detection apparatus 208 is implemented using at least one computing device (e.g., one or more processors), and can include one or more machine learning models. The overlay area detection apparatus 208 is configured to determine an overlay position of the additional content, e.g., the text 224 and/or the interactive element, in a way that prevents the salient features of the image 222 from being partially and/or completely occluded by the additional content. For example, the car in the image 222 is located closer to the bottom than the top of the image 222, such that when the text 224 is overlaid (or otherwise combined with the image 222) the text 224 does not occlude the car depicted in the image 222. If the image includes a person, the overlay area detection apparatus 208 can be configured to select an overall position that does not occlude the person's face or other salient part of the person (e.g., a shirt if the subject of the digital component is the shirt).

In some cases, the overlay position is selected to optimize the clarity of the additional content and enhance the overall aesthetics of the digital component 226. For example, in some cases, the overlay area detection apparatus 208 can detect more than one candidate overlay areas that are outside of the salient features area(s). To optimize or at least improve the overlay location, the overlay area detection apparatus 208 can identify an area with minimal background clutter to ensure the text 224 is easily readable.

The overlay area detection apparatus 208 can use any appropriate technical or machine learning model to identify the overlay position of each item of the additional content. In one example, the overlay area detection apparatus 208 can use a search technique that systematically explores potential overlay positions within the image 222, guided by constraints such as avoiding salient features, factoring in content properties (size, aspect ratio, colors), and optionally considering overall image composition for an aesthetically pleasing result.

Various approaches can be adopted to optimize or at least improve the efficiency of the search technique. In one example, hierarchical search can be employed. The overlay area detection apparatus 208 can start with a coarse-grained search to quickly identify promising regions, and narrow the search space, and use a finer-grained search within those regions for more precise solutions. In another example, overlay area detection apparatus 208 can use heuristic features to eliminate unpromising areas early based on simple heuristics. For example, the overlay area detection apparatus 208 can discard regions significantly overlapping salient features, or those that are vastly too small for the content.

In some cases, the overlay area detection apparatus 208 can implement parallelization strategies to facilitate concurrent exploration of multiple candidate overlay positions, thereby accelerating the search process and reducing computational overhead. Furthermore, the overlay area detection apparatus 208 can perform adaptive adjustments of search parameters based on the characteristics of the input image and content properties to enhance the overlay area detection apparatus' adaptability to diverse scenarios.

In some cases, the overlay area detection apparatus 208 can use machine learning models, such as reinforcement learning or neural networks, which enable the overlay area detection apparatus 208 to learn and refine its decision-making process over time, improving its effectiveness in identifying optimal overlay positions.

In some cases, the overlay area detection apparatus 208 can leverage efficient data structures and algorithms for storing and processing salient feature information, enabling streamlining the search process and enhancing overall performance of the algorithm.

The style feature selection apparatus 234 is implemented using at least one computing device (e.g., one or more processors), and can include one or more machine learning models. The style feature selection apparatus 234 is configured to select one or more style features for the digital component 226. The style features can include image effects for styling the image 222 and/or style features for styling the additional content. For example, the style features can include text style features for the text 224 or element style features for an interactive element overlaid on the image 222.

Examples of image effects can include a brightness adjustment effect, a contrast adjustment effect, a sharpen or blur effect, a color adjustment effect, a distortion effect, a 3D image effect, a torn edge effect, and other image filter effects. Examples of text style features can include a font typeface, a font color, a font weight, a font style, a text alignment, a text spacing, or other text display effects (e.g., 3D effects, shadow effects, gradient effects, etc.) Examples of element style features can include a button shape, a button color, or a button pattern.

A goal of the style feature selection apparatus 234 is to select style features tailored to the subject matter of the digital component 226 to enhance its ability to effectively deliver information and capture audience attention and/or engagement. Furthermore, the selected styles should form a visually cohesive and pleasing overall design. The following operations aim to achieve these goals.

The style feature selection apparatus 234 generates a prompt 218 (e.g., a textual description) describing the intended subject of the digital component 226. The style feature selection apparatus 234 submits the prompt 218 to the language model 202 and receives from the language model 202 an output 220 that includes one or more keywords characterizing the subject of the digital component 226. These keywords are used to determine the style features selected for the digital component 226.

In some cases, the language model 202 has been conditioned, e.g., through explicit constraints specified in the prompt 218 and/or through contextual learning, to output keywords that are selected from a finite list of keyword combinations. The contextual learning can be performed by prompting the language model 202 with a set of examples with each example including a respective input description and a respective output set of keywords.

In some cases, the style feature selection apparatus 234 determines the style feature selections by querying the style feature database 218 stored in the memory structure 240. In these cases, the style feature database 218 stores a set of data entries with each respective structured data entry linking a respective set of keywords with a respective set of style features 228. In other words, the style feature database 218 links each particular set of keywords that characterize certain subject matter with a particular set of style feature combinations. As described above, the style features 228 can include image effects and/or style features for the text or the interactive elements. The data entries in the style feature database 218 can be obtained in any of a variety of means. In some cases, the data entries can be generated based on expert inputs. In other cases, the data entries can be generated by a machine learning model that has been trained to output optimal style feature selections for a combination of keywords.

In an illustrative example, the subject of the digital component 226 is a children's party. In this case, the prompt 218 describes the event, such as “Please come to Sylvia's 8th birth party on April 22. Cake and pizzas will be served, and fun games.” The language model 202 processes the prompt 218 to generate a list of keywords that characterize the subject, including “fun”, “excitement”, and “children.” The style feature selection apparatus 234 queries the style feature database 218 for the set of keywords of “fun”, “excitement”, and “children”, and identifies a combination of style features including “Comic Sans font” and “enhanced color saturation for the image” that are associated with the set of keywords.

In another illustrative example, the subject of the digital component 226 is a sports car. In this case, the prompt 218 describes the subject, such as “Unleash your inner thrill-seeker. Introducing the [Car Model], where precision engineering meets heart-pounding performance.” The language model 202 processes the prompt 218 to generate a list of keywords that characterize the subject, including “luxury”, “excitement”, and “speed.” The style feature selection apparatus 234 queries the style feature database 218 for the set of keywords of “luxury”, “excitement”, and “speed”, and identifies a combination of style features including “metallic color theme”, “bold geometric fonts”, and “motion blur filter for the background” that are associated with the set of keywords.

In some cases, after the style features 228 have been selected, the AI system 160 can apply these features to the generated digital component 226. In some cases, one or more style features can be directly applied to the digital component 226, e.g., by modifying the pixels within the digital component 226. In some cases, one or more style features can be stored with digital component 226 as configuration data and/or codes, to be applied when the digital component 226 is rendered on a display interface.

In some cases, the AI system 160 can select the style features of additional content, e.g., the text 226 and/or interactive elements, overlaid on the image 222 based on the style features of the image 222, such that the additional content is readable. For example, the AI system 160 can adjust the color, size, and/or other characteristics of the text 226 and/or the interactive elements based on the color palette and contrast of the image 222 after the image effects have been applied to so that the overlaid content has a sufficient level of contrast relative to the image 222.

Once the new digital component 226 is generated and styled, it can be stored in the digital components database 216. In some implementations, the new digital component 226 can be stored in association with distribution parameters (e.g., a subject category or other keywords as described herein) and/or a size of the digital component. This can facilitate efficient selection of an appropriate digital component to transmit to the client device 204 in response to a request for content 232 received from the client device 204.

For example, when the request for content 232 is received, aspect ratio data, dimensions, or other indications of the space available for presentation of a digital component in an electronic resource can be identified. More specifically, in some situations, the request for content may specify that the space in the electronic document that is available for presentation of a digital component is an A×B pixel space. In these situations, the AI system 160 can determine whether the new digital component 226 fits in the available space based on the aspect ratio, dimensions, or other indications of space available (e.g., based on a comparison of the space available and the stored size information for the new digital component). In response to determining that the new digital component 226 will fit in the available space, the AI system 160 can select the new digital component 226 for presentation, and transmit the new digital component 226 to the client device 204.

The creation of the new digital component 226 can be performed prior to the receipt of the request for content 232 from the client device 204, or after the request for content 232 has been received. For example, a set of new digital components (e.g., including the digital component 226) can be created and stored for later distribution independent of any request for content from a client device.

In some cases, the new digital component 226 can be created in response to receipt of the request for content 232 from the client device 204. For example, when the request for content 232 is received, the subject category and/or dimensions specified therein can be identified and used to select (i) one or more images from the images database 212 and (ii) one or more phrases from the text database 214. Additional information, such as a time of day, device type of the client device 204, or other information can be used during the selection of the image 226 and/or text 228. Once the image 226 and text 228 have been selected, they can be combined to create the new digital component 226, which can then be styled according to the style features selected by the style feature selection apparatus 234. The AI system 160 can then transmit the new digital component 226 to the client device 204 for presentations. In these implementations, the new digital component 230 can also be stored in the digital components database 216, and used again later for distribution to other client devices 204, thereby reducing the need to recreate the new digital component 230 in response to a subsequent request for content.

In some cases, certain operations of generating the digital component 226 can be performed prior to the receipt of the request for content 232 from the client device 204, while certain other operations of generating the digital component 226 can be performed in response to receiving the request for content 232 from the client device 204. For example, image selection, salient feature detection, image cropping, and determination of the overlay positions, can be performed prior to the receipt of the request for content 232. Operations such as combining the image with the text and applying certain styling features can be performed in response to receiving the request for content 232. This way, the system provides more flexibility in customizing the digital component to a particular scenario while reducing latency.

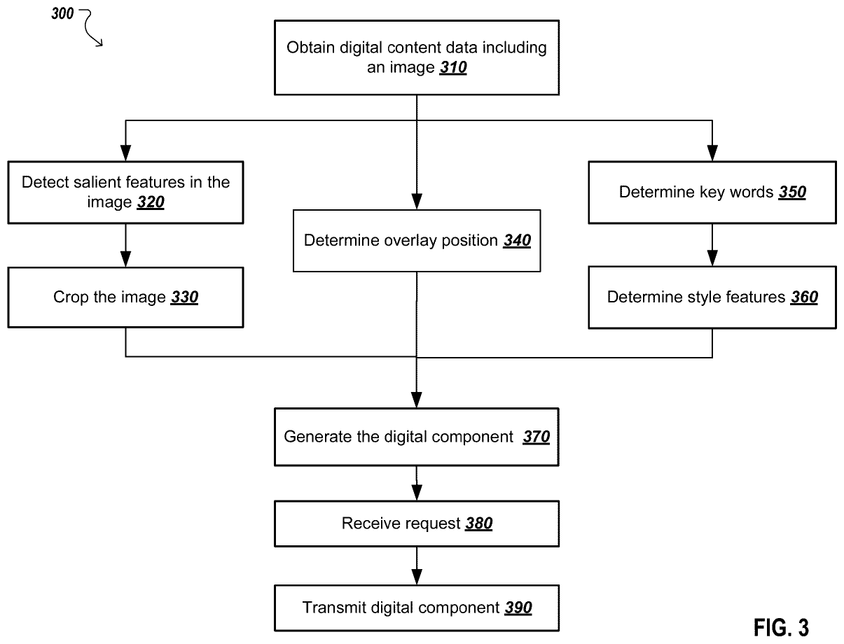

FIG. 3 is a flow diagram of an example process 300 for generating a digital component using artificial intelligence. Operations of the process 300 can be performed by a system of one or more computers located in one or more locations, e.g., the AI system 160 described with references to FIG. 1 and FIG. 2, appropriately programmed in accordance with this specification. Operations of the process 300 can also be implemented as instructions stored on one or more computer-readable media, which may be non-transitory, and execution of the instructions by one or more data processing apparatus can cause the one or more data processing apparatus to perform the operations of the process 300. For convenience and without loss of generality, the process 300 will be described as being performed by a data processing apparatus, e.g., a computer system.

At 310, the system obtains digital content data. The digital content data includes an image and may additionally include additional content, such as text and/or interactive elements. As described above, the system can select the digital content data from one or more databases stored in a memory structure.

At 320, the system detects salient features in the image. In some cases, the system can detect the salient features by processing the image using a feature detection machine learning model to generate an output identifying areas corresponding to the salient features of the image.

At 330, the system crops the image according to a specified size or aspect ratio. The cropping is performed based on the determined salient features such that the cropped image includes the salient features.

At 340, the system determines one or more display positions of the additional content. For example, the system can determine a display position of a text item or an interactive element overlaid on the image. In some cases, to determine a display position of a text item or an interactive element, the system determines a set of candidate display areas in the image that are outside of salient features of the base image, and selects the display position in one of the candidate display areas.

At 350, the system determines one or more keywords characterizing a subject of the digital component. In particular, the system generates a prompt including a description of the subject, and processes the prompt using a language model to generate the keywords.

In some cases, prior to using the language model to generate the keywords, the system performs contextual learning of the language model using a set of examples. Each example includes a respective input description and a respective output set of keywords.

At 360, the system determines one or more style features for the digital component based on the keywords. The style features can include one or more image effects, such as a brightness adjustment effect, a contrast adjustment effect, a sharpen or blur effect, a color adjustment effect, a distortion effect, a 3D image effect, or a torn edge effect.

When one or more text items are to be included in the digital component, the style features can include one or more text style features for the text items, such as a font typeface, a font color, a font weight, a font style, a text alignment, a text spacing, or one or more text display effects.

When one or more interactive elements are to be included in the digital component, the style feature can include one or more element style features for the interactive elements, such as a button shape, a button color, or a button pattern.

In some cases, to determine the style features of the digital component based on the keywords, the system can refer to a database storing a set of structured data items with each respective structured data item linking a respective set of keywords with a respective set of style features, and identify the style features that are associated with the keywords outputted by the language model.

At 370, the system generates the digital component by processing the digital content data based at least on determined style features. In particular, the system can combine the image with the additional content (e.g., text and/or interactive elements) based on the display positions determined for the additional content. The system applies the determined style features to the image and/or the additional content.

At 380, the system receives a request for content related to the subject, and at 390, the system transmits the digital component to a client device in response to the request.

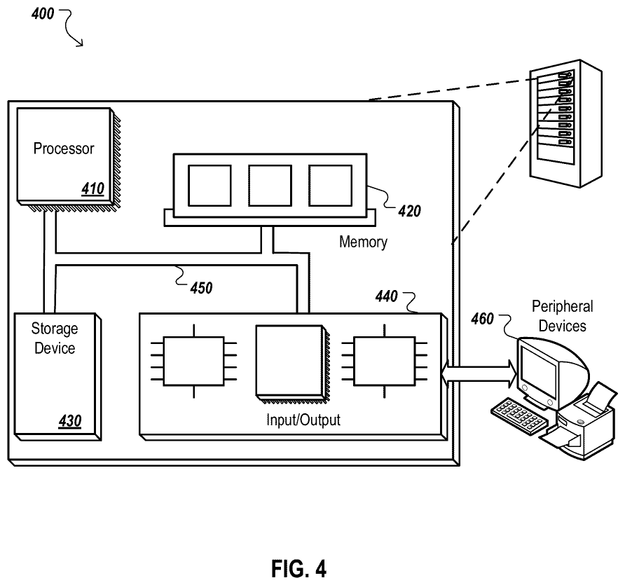

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for generating a digital component, comprising:
obtaining digital content data for the digital component, the digital content data comprising at least a base image of a subject of the digital component;
obtaining a prompt comprising a description of the subject;
processing the prompt using a language model to generate one or more keywords related to the subject;
determining, based on the one or more keywords, one or more style features for the digital component;
generating the digital component by processing the digital content data based at least on the one or more determined style features; and
distributing the generated digital component to one or more client devices.

2. The method of claim 1, further comprising:
storing a set of structured data items with each respective structured data item linking a respective set of one or more keywords with a respective set of one or more style features, wherein determining, based on the one or more keywords, the one or more style features of the digital component comprises:
identifying, in the set of structured data items, the one or more style features as a respective set of style features that are linked to the one or more keywords.

3. The method of claim 1, further comprising:
determining salient features of the base image; and
cropping the base image based on the determined salient features such that the cropped base image includes the determined salient features and an additional are for adding text to the image.

4. The method of claim 3, wherein determining the salient features of the base image comprises:
processing the base image using a feature detection machine learning model to generate an output identifying the salient features of the base image.

5. The method of claim 1, wherein the one or more style features comprise one or more image effects, and generating the digital component comprises:
applying the one or more image effects to the base image.

6. The method of claim 5, wherein the one or more image effects comprise: a brightness adjustment effect, a contrast adjustment effect, a sharpen or blur effect, a color adjustment effect, a distortion effect, a 3D image effect, or a torn edge effect.

7. The method of claim 1, wherein the digital content data further comprises a text item, and generating the digital component comprises overlaying the text item on the base image.

8. The method of claim 7, wherein overlaying the text item on the base image comprises:
determining a display position of the text item relative to the base image in the digital component.

9. The method of claim 8, wherein determining the display position of the text item relative to the base image comprises:
determining a set of one or more areas in the base image that are outside of salient features of the base image; and
selecting the display position in a first area in the set of one or more areas.

10. The method claim 7, wherein the one or more style features comprise one or more text style features for the text item, and generating the digital component comprises applying the one or more text style features to the text item in the generated digital component.

11. The method of claim 10, wherein the one or more text style features comprises one or more of: a font typeface, a font color, a font weight, a font style, a text alignment, a text spacing, or one or more text display effects.

12. The method of claim 1, wherein the digital content data further comprises an interactive element, and generating the digital component comprises combining the interactive element with the base image.

13. The method of claim 12, wherein combining the interactive element with the base image comprises:
determining a display position of the interactive element relative to the base image in the digital component.

14. The method of claim 12, wherein the one or more style features comprise one or more element style features for the interactive element, and generating the digital component comprises applying the one or more element style features to the interactive element in the generated digital component.

15. The method of claim 14, wherein the one or more element style features comprises one or more of: a button shape, a button color, or a button pattern.

16. The method of claim 1, further comprising:
performing contextual learning of the language model using a set of examples, each example comprising a respective input description and a respective output set of keywords.

17. A system comprising:
one or more computers; and
one or more storage devices storing instructions that when executed by the one or more computers, cause the one or more computers to perform operations for generating a digital component, the operations comprising:
obtaining digital content data for the digital component, the digital content data comprising at least a base image of a subject of the digital component;
obtaining a prompt comprising a description of the subject;
processing the prompt using a language model to generate one or more keywords related to the subject;
determining, based on the one or more keywords, one or more style features for the digital component;
generating the digital component by processing the digital content data based at least on the one or more determined style features; and
distributing the generated digital component to one or more client devices.

18. The system of claim 17, wherein the operations further comprise:
storing a set of structured data items with each respective structured data item linking a respective set of one or more keywords with a respective set of one or more style features, wherein determining, based on the one or more keywords, the one or more style features of the digital component comprises:
identifying, in the set of structured data items, the one or more style features as a respective set of style features that are linked to the one or more keywords.

19. The method of claim 17, wherein the operations further comprise:
determining salient features of the base image; and
cropping the base image based on the determined salient features such that the cropped base image includes the determined salient features and an additional are for adding text to the image.

20. One or more non-transitory computer-readable storage media storing instructions that, when executed by one or more computers, cause the one or more computers to perform operations for generating a digital component, the operations comprising:
obtaining digital content data for the digital component, the digital content data comprising at least a base image of a subject of the digital component;
obtaining a prompt comprising a description of the subject;
processing the prompt using a language model to generate one or more keywords related to the subject;
determining, based on the one or more keywords, one or more style features for the digital component;
generating the digital component by processing the digital content data based at least on the one or more determined style features; and
distributing the generated digital component to one or more client devices.
